(19) United States
(12) Patent Application Publication
(10) Pub. No.: US 2017/0341960 A1
(43) Pub. Date: Nov. 30, 2017

(54) REMOVAL OF SELENIUM FROM COAL MINE WASTEWATER

(71) Applicant: Analabs, Inc., Crab Orchard, WV (US)

(72) Inventor: Charles THOMPSON, Crab Orchard, WV (US)

(21) Appl. No.: 15/604,789

(22) Filed: May 25, 2017

Related U.S. Application Data
(60) Provisional application No. 62/341,449, filed on May 25, 2016.

(51) Int. Cl. C02F 1/52; C02F 1/66; C02F 101/10; C02F 103/10; C02F 1/00

(52) U.S. Cl. CPC C02F 1/5236; C02F 1/66; C02F 2001/007; C02F 2103/10; C02F 2101/106

(57) ABSTRACT

A system, a method and a process is provided for removing selenium from coal mine wastewater. The method and system include the steps of providing a quantity of ferric chloride in a predetermined relative ratio to a volume of mine wastewater, using sodium hydroxide to adjust the pH of the mine wastewater between 7.5 and 8, introducing the volume of mine wastewater into a sediment pond or tank having turbidity curtains.

This patent application claims priority to and the benefit of U.S. Provisional Patent Application No. 62/341,449 filed May 25, 2016, entitled “REMOVAL OF SELENIUM FROM COAL MINE WASTEWATER”, which is hereby incorporated by reference.

### BACKGROUND

The application generally relates to removal of Selenium from coal mine wastewater. The application relates more specifically to a method, process and apparatus for removal of Selenium from coal mine wastewater.

Selenium is a regulated chemical element that is naturally present in mine wastewater. Selenium is subject to regulations on effluent limitations that strictly limit the discharge of effluent into streams. In some cases the allowable concentration of Selenium may be no greater than 4.7 parts per billion (ppb). Such an extremely low concentration makes compliance difficult, if not impossible, for coal mine operators. Existing solutions for removal of selenium are extremely costly and difficult to achieve.

Intended advantages of the disclosed systems and/or methods satisfy one or more of these needs or provide other advantageous features. Other features and advantages will be made apparent from the present specification. The teachings disclosed extend to those embodiments that fall within the scope of the claims, regardless of whether they accomplish one or more of the aforementioned needs.

### SUMMARY

One embodiment relates to a method and a process for removing selenium from coal mine wastewater comprising providing a quantity of ferric chloride in a predetermined relative ratio to a volume of mine wastewater, using sodium hydroxide to adjust the pH of the mine wastewater between 7.5 and 8, introducing the volume of mine wastewater into a sediment pond or tank having turbidity curtains.

Another embodiment relates to a system for removing selenium from mine wastewater including a means for determining a concentration ratio of ferric chloride for a predetermined volume or range of volumes of mine wastewater, a means for introducing the determined amount of ferric chloride, a vessel for storing the volume of mine wastewater, the vessel including a plurality of turbidity curtains having windows for flow of mine wastewater therethrough for clarification of the mine wastewater and settling of the solids, and means for discharging the mine wastewater after treatment.

Certain advantages of the embodiments described herein are removal of selenium from mine wastewater to prevent contamination of streams and waterways.

Alternative exemplary embodiments relate to other features and combinations of features as may be generally recited in the claims.

### BRIEF DESCRIPTION OF THE FIGURES

The application will become more fully understood from the following detailed description, taken in conjunction with the accompanying FIGURES, wherein like reference numerals refer to like elements, in which:

FIG. 1 shows an exemplary embodiment of a method and treatment for removal of selenium from mine wastewater.

### DETAILED DESCRIPTION OF THE EXEMPLARY EMBODIMENTS

Before turning to the FIGURES which illustrate the exemplary embodiments in detail, it should be understood that the application is not limited to the details or methodology set forth in the following description or illustrated in the FIGURES.

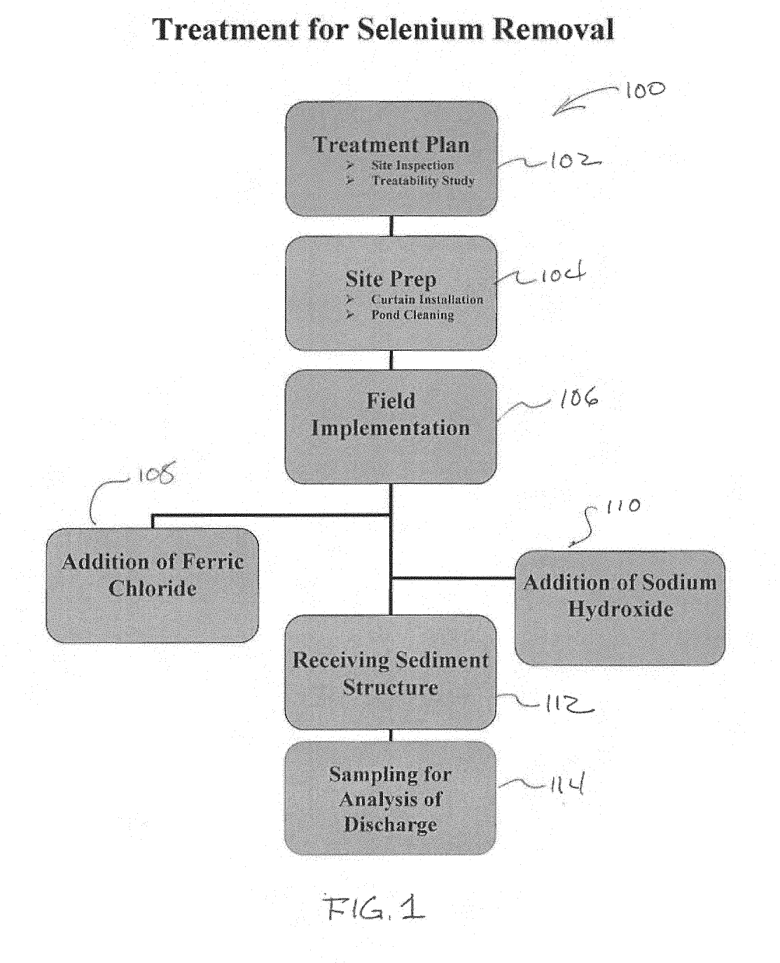

Referring to FIG. 1, the removal of selenium from coal mine wastewater is a process 100 of combining one or more chemical components in the correct proportion, as determined from field testing and measurements taken at mine wastewater discharge and collection sites, as indicated at step 102. At step 104, site preparation is performed, which includes installation of turbidity curtains and cleaning of a retention pond that holds the volume of water that includes selenium. At step 106 field implementation involves setting up equipment and staging operations for mixing components for selenium removal. The removal process includes the mixing ferric chloride with the mine wastewater to extract selenium in the mine wastewater, at step 108, and adding sodium hydroxide to the mine wastewater to provide for adjustment of the pH of the mine wastewater between 7.5 and 8, at step 110.

At step 112 a receiving sediment structure is constructed with sufficient depth to store the resultant sludge. The sediment structure may be equipped with turbidity curtains with windows to produce clarified water that can be discharged, e.g., via pumps, drainpipes, and conventional water discharge equipment, into receiving streams. If all of the conditions set for the above are met, in practice compliance limits with selenium may be achieved. At step 114 the treated mine wastewater discharge is sampled for analysis.

It should also be understood that the phraseology and terminology employed herein is for the purpose of description only and should not be regarded as limiting. While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

It should be noted that although the FIGURES or written description herein may disclose a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the application.

1-2. (canceled)

3. A method for removing selenium from wastewater comprising:
providing a quantity of ferric chloride in a predetermined relative ratio to a volume of wastewater;
adjusting a pH of the volume of wastewater; and
introducing the volume of wastewater into a vessel.

4. The method of claim 1, wherein the adjusting of the pH is achieved by adding sodium hydroxide to the mine wastewater.

5. The method of claim 2, wherein the pH is adjusted to a slightly alkaline value.

6. The method of claim 3, wherein the pH value is in the range of 7.5 to 8.

7. The method of claim 1, wherein the wastewater vessel is a sediment pond.

8. The method of claim 1, wherein the wastewater vessel is a tank.

9. The method of claim 1, further comprising receiving the wastewater from a coal mine discharge location.

10. The method of claim 1, wherein the wastewater volume is held in a pond or tank.

11. The method of claim 8, further comprising providing turbidity curtains in the pond or tank.

12. A system for removing selenium from wastewater including:
means for determining a concentration ratio of ferric chloride;
means for introducing the determined amount of ferric chloride into a volume of wastewater;
a vessel for storing the volume of wastewater, and means for discharging the wastewater after treatment.

13. The system of claim 10, wherein the concentration of ferric chloride is determined for a range of volumes of wastewater.

14. The system of claim 10, wherein the vessel comprises a plurality of turbidity curtains.

15. The system of claim 12, wherein the turbidity curtains comprise windows for flow of wastewater therethrough.

16. The system of claim 10, wherein the windows in the turbidity curtains are configured to achieve clarification of the wastewater and settling of solids in the wastewater.

17. A process for removing selenium from wastewater comprising:
combining one or more chemical components in a predetermined proportion preparing a water treatment site by installing turbidity curtains in a retention pond;
providing a predetermined volume of wastewater in the retention pond;
cleaning the retention pond;
providing a quantity of ferric chloride and a quantity of sodium hydroxide; and
mixing a predetermined quantity of ferric chloride with the wastewater to extract selenium in the mine wastewater

18. The process of claim 15, further comprising adding sodium hydroxide to the wastewater

19. The process of claim 16, further comprising adjusting the pH of the volume of wastewater.

20. The process of claim 17, wherein the pH of the volume of wastewater is adjusted to a pH value in the range of 7.5 to 8.

21. The process of claim 15, wherein the quantity of the ferric chloride and the quantity of sodium hydroxide are determined, respectively, on field testing and measurements of selenium concentration in the wastewater.

22. The process of claim 19, wherein the field testing and measurements of selenium is determined at the location of mine wastewater discharge and collection sites.
